(19) United States
(12) Patent Application Publication
(10) Pub. No.: US 2006/0253405 A1
(43) Pub. Date: Nov. 9, 2006

(54) Post-delivery mail management system and method

(76) Inventor: Peter Nirenberg, Millburn, NJ (US)

Correspondence Address: FLESHNER & KIM, LLP, P.O. BOX 221200, CHANTILLY, VA, 20153, US

(21) Appl. No.: 11/119,706

(22) Filed: May 3, 2005

(51) Int. Cl. G06Q 99/00; G06F 17/00

(52) U.S. Cl. 705/401; 705/1

(57) ABSTRACT

A mail management system transmits scanned images of unopened, delivered mail to a remotely located recipient, and then interactively receives commands from the recipient on how the mail is to be handled. Each scanned image is preferably associated with a secondary image including information relating to a mail management function. The scanned images and commands may be transmitted through any one of a variety of communications network (e.g., the Internet) for convenience of use.

### BACKGROUND OF THE INVENTION

1. Field of the Invention.

This invention generally relates to systems and methods for managing mail which is designated for remote delivery from the original delivery point.

2. Description of the Related Art.

There are a number of circumstances where mail delivered to remote recipients cause extensive delivery problems. As an example, Post Office Boxes provide a convenient and efficient way of receiving mail for a variety of individuals and corporations. Unfortunately, these boxes are remotely located from their owners. As a result, owners must make special trips to the post office, often on a daily basis, to determine what mail they have received. This has proven to be time-consuming and inconvenient, especially when the box owners are on travel and/or are waiting to receive checks, important letters, or special classes of mail.

Another example of remote mail delivery problems are government or commercial enterprise mail centers who are frequent recipients of mail which is intended another location. This mail could be mail for branch offices, employee home offices, or expatriate mail. This causes excess cost of rerouting mail and delays in delivery to the recipient.

A third example of where remote delivery recipients are in need of a service is from the private or public mail carriers to provide an advance notification describing the nature and status of mail delivery items. This notification would include an interactive instruction to the carrier for alternative delivery or handling procedures. Typically, these remote recipients are extensively away from the home delivery location and cause wasted deliveries or delayed access to the mail.

### SUMMARY OF THE INVENTION

An object of the present invention is to provide a system and method that allows an individual, corporation, or other entity who are located remotely from the original delivery mail center to provide interactive instruction back to the original delivery or accepting point as to the most efficient means of handling their mail. This may be accomplished through a interactive Internet Post Office box notification system.

Another object of the present invention is to solve a widespread and common problem of picking up postal mail after the USPS or private carrier has properly completed delivery of it to its intended destination. What happens though when intended destination is not the current or real destination such as someone's home, overseas office or hotel and the recipient is not going to be at the mail center for some time? Or perhaps the mail center is miles away and you have no way of knowing if an important letter is waiting for you! This invention, in at least one of its embodiments, lets the intended recipient view a picture of the actual unopened letters in their mail box or mail center and interactively ask that some of the mail items be deleted, couriered to a new address, forwarded to someone else, opened and scanned for digital delivery, or just kept in the mail center.

Further, in at least one or more embodiments of this invention, the recipient has complete and final say over the timeliness and type of delivery they ultimately receive. No more unnecessary trips to the mail center and no more delays in receiving vital postal mail.

These and other objects and advantages may be achieved by providing a post-delivery mail management system which, in accordance with one embodiment, includes a scanner to capture a first image of at least one side of a mail item delivered to an original delivery point, a digital processor to append a second image to the first image of the mail item, and a workstation to transmit the first image of the mail item with the appended second image to a remote delivery recipient. The digital processor may be located separately from or included as part of the workstation. The second image may include information relating to a management function performed by a mail manager of the original delivery point. For example, the second image may include textual information (e.g., identification code, name, address, etc.) identifying or otherwise relating to the remote delivery recipient and/or the items of mail being scanned.

The scanner captures an image of one or more sides of exterior portions of the mail items. This may be performed by automated equipment or by a hand scanner. The field of view of the scan preferably includes all information considered important to the remote delivery recipient in making a decision concerning how the mail items should be disposed. When the mail items are letters, only one side may be scanned or the front and back sides of the letters may be scanned simultaneously for transmission to the remote delivery recipient.

The workstation may transmit at least one of the first and second images in a number of ways. For example, the images may be transmitted according to a predetermined schedule programmed into a workstation processor. Alternatively, the images may be transmitted in response to activation of a hyperlink received through the Internet. As a further alternative, the images may be transmitted by fax or as an e-mail attachment, or in response to a request signal transmitted by the remote delivery recipient. The request signal may be received through a website corresponding to the manager of the original delivery point.

The workstation also receives one or more interactive commands from the remote delivery recipient indicating a manner of disposition of a mail item. The commands may instruct the manager, for example, to discard or destroy an unopened mail item, open and scan the contents of the mail item for transmission to the remote delivery recipient, forward the mail item by public or private carrier, or hold the mail item for the delivery recipient.

In accordance with another embodiment, a post-delivery mail management method includes receiving a first electronic signal at a terminal of a remote delivery recipient, with the first electronic signal including at least one image of a scanned mail item delivered to an original delivery point. The at least one image of the scanned mail item is displayed on a screen of the terminal. A second electronic signal is then generated to include at least one command relating to a manner of disposition of the mail item. The second electronic signal may be transmitted from the terminal to a manager of the original delivery point in response to the first electronic transmission.

The method also includes displaying a number of management options on the terminal screen and receiving a signal from an input device selecting one or more of the options. The instruction in the second electronic signal may include information corresponding to the selected options. The options may be displayed as selectable icons preferably in association with the at least one image of the mail item displayed on the screen.

The method also includes associating a graphic indicative of the at least one command with the image of the mail item, and transmitting the second electronic signal to include the graphic in association with the image of the mail item.

The method also includes providing access to the images and transmitting corresponding instructions through a website. The remote recipient may be required to log into the website using, for example, a registered user identifier and password. The recipient may also send a request for status of the original delivery point through the website, and may receive the first electronic signal in response to the request.

The method also includes receiving notification that one or more mail items have been delivered to the original delivery point, sending a request in response to activation of a hyperlink on the terminal screen, and receiving the first electronic signal in response to the request. Once the notification has been received, the appearance of an icon may be automatically modified or animated on the terminal screen of the remote delivery recipient. The icon may also correspond to the hyperlink. Additionally, the first electronic signal may be received with an e-mail from the mail manager of the original delivery point, and the second electronic signal may also be transmitted as an e-mail.

The embodiments of the present invention are advantageous in that they provide remote delivery recipients with immediate and advanced knowledge of the contents of their original delivery points, saving them the expense and aggravation of having to visit these points to determine what mail they may have received. This invention also provide a lower cost alternative to the original delivery mail acceptance center for rerouting or handling of this remote delivery mail. Further, mail items may be purged with the simple press of a button, or can be forwarded by any delivery method to other locations. The embodiments of the invention also reduce the accumulation of paper in an office or home, e.g., junk mail can be discarded at a P.O. Box without it ever being sent to the remote recipients home or place of business. The invention also creates a new market for generating revenue for public and commercial entities. Other benefits and advantages are also evident.

### BRIEF DESCRIPTION OF THE DRAWINGS

FIG. 1 is a diagram showing a post-delivery mail management system according to one embodiment of the present invention.

FIG. 2 is a diagram showing one possible implementation of the mail manager site in FIG. 1, in the illustrative case where the original delivery point includes a P.O. Box.

FIG. 3 is a flow diagram showing steps included in one embodiment of a post-delivery mail management method of the present invention.

FIGS. 4A-4H are diagrams showing non-limiting examples of images of front-sides of mail items that may be scanned and sent to the remote delivery recipient in accordance with one embodiment of the present invention.

FIG. 5 is a diagram showing one type of scanner for capturing front- and back-side images of mail items in accordance with one embodiment of the present invention.

FIG. 6 is a diagram showing one way scanned mail items may be transmitted to a remote delivery recipient in accordance with one embodiment of the present invention.

FIG. 7A is a diagram showing one type of graphical user interface that may be used in accordance with one embodiment of the present invention to display scanned images received by a computer of the remote delivery recipient and how instructions concerning the disposition of mail items corresponding to the images may be generated, and FIG. 7B is a diagram showing a different type of graphical user interface that may be used in accordance with another embodiment.

FIG. 8 is a conceptual diagram showing one illustrative agreement that may be formed between the mail manager and remote delivery recipient in accordance with one embodiment of the present invention.

FIGS. 9A and 9B are diagrams showing examples of icons that may be used in accordance with one or more embodiments of the present invention.

FIGS. 10A and 10B are diagrams showing other icon examples that may be used in accordance with one or more embodiments of the present invention

FIG. 11 is a diagram showing scanned images of mail items which may be transmitted with selectable icons for providing mail management instructions in accordance with one embodiment of the present invention.

FIG. 12 is a diagram showing an example of how an e-mail may be generated with textual instructions for disposing of mail in accordance with an alternative embodiment of the present invention.

### DESCRIPTION OF THE PREFERRED EMBODIMENTS

The present invention is a system and method for allowing a person, corporation, or other entity to remotely manage items of mail, preferably after the mail has been delivered to a designated location or address. The mail items may be letters, packages, parcels, magazines, periodicals, newspapers, merchandise, shipments, and/or any other objects designated for delivery by a public or private carrier. The public carrier may, for example, be the U.S. Postal Service or, if outside this country, a delivery service sponsored, controlled by, or otherwise affiliated with a government entity. Private carriers include FedEx, UPS, DHL, or other delivery companies or service not under government control. In accordance with at least one particularly advantageous embodiment, the system and method are bi-directionally employed to allow a managing entity to control disposition of delivered mail items interactively, for example, through a website. In other embodiments, the interactive control is performed through other techniques.

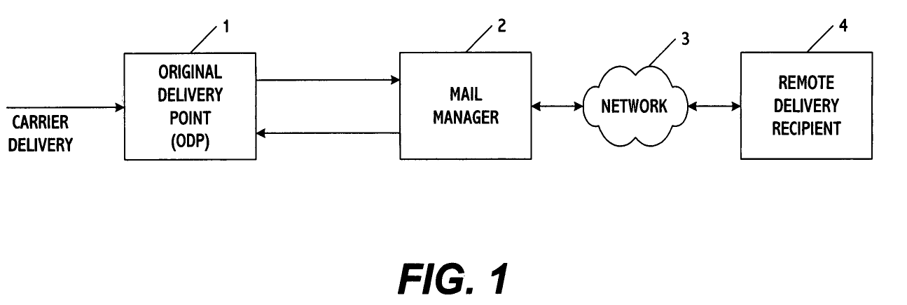

FIG. 1 shows a post-delivery mail management system in accordance with one embodiment of the present invention. The system includes an original delivery point 1, a mail manager 2, a communications network 3, and a site 4 of a remote delivery recipient. The original delivery point is remotely located from the delivery recipient site and may correspond, for example, to a post office box, a private mail box, a government or corporate site or mail room, or even a private residence. As an example, the private box may be one leased from Mail Boxes Etc. or another commercial entity. The original delivery point may receive items of mail (broadly defined above) from public and/or private carriers as indicated.

The mail manager may be any person, business entity, or organization authorized to receive, store, and/or access mail items delivered to the original delivery point. In accordance with one embodiment, when original delivery point is a P.O. box, the mail manager may be the post office. Alternatively, the mail manager may be the leasor (e.g., Mail Boxes Etc.) of a commercial or private mail box. In other embodiments, the mail manager may be a government office or corporation when the delivery point is a corresponding mail room. In other embodiments, the mail manager may be a business center, retail store (e.g., Kinkos), headquarters office center, or a third party authorized to access mail items for the remote delivery recipient.

Regardless of the type, each mail manager maintains or has access to a workstation for managing mail items in accordance with instructions from the remote delivery recipient. As will be described in greater detail, the workstation is equipped with or linked to processing equipment that scans exterior portions of the mail items after they have been delivered. The scanned images are then transmitted to the remote delivery recipient through the communications network, e.g., the Internet, a public switched telephone network, local-area network, wide-area network, virtual-private network, wireless communications network, or any other optical, wireless, or electrical communication path.

The workstation is further equipped to receive interactive instructions from the remote delivery recipient, and then to take action regarding disposition of the mail based on those instructions. The action may be performed automatically or in association with one or more duties performed by the mail manager. To enable this interactivity, the link between mail manager 2 and delivery recipient 3 is preferably bidirectional. In alternative embodiments, different communication paths may be used to carry the scanned images and recipient instructions. For example, the scanned images may be transmitted via e-mail or the Internet and the recipient instructions may be given through voice or faxed commands. For convenience purposes, all transmissions may be performed via e-mail or the Internet, however this is not a necessity.

The remote delivery recipient may be any private or public entity. The invention is particularly well suited to individuals who, for example, travel frequently and/or receive mail at multiple addresses, e.g., a person who owns multiple houses in different parts of the country. The invention, however, may be equally beneficial to businesses who, for example, receive mail at multiple addresses.

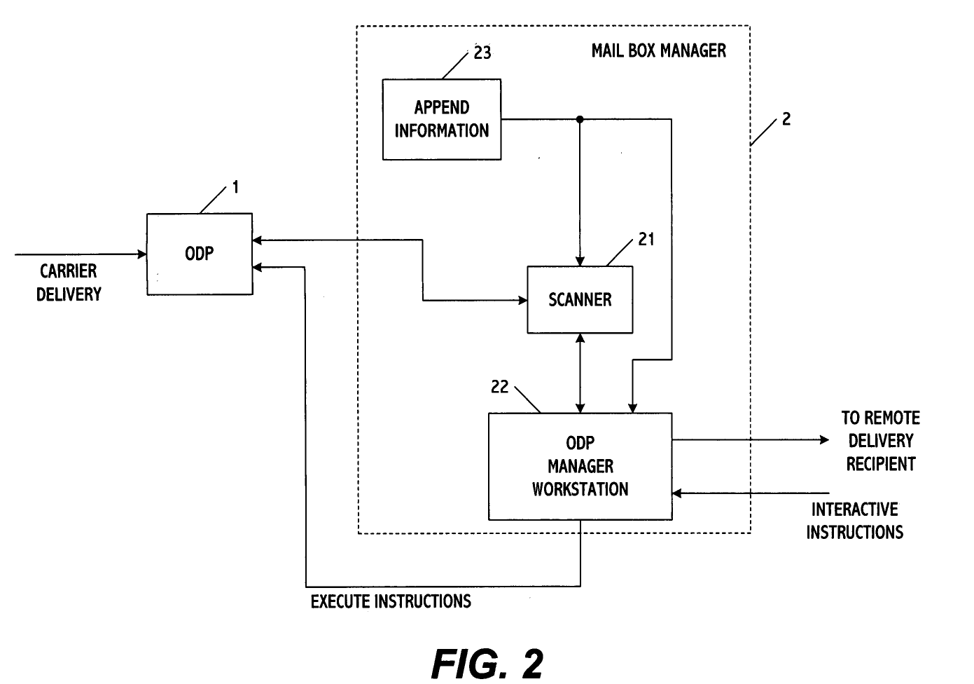

FIG. 2 shows one possible implementation of the mail manager site in FIG. 1, in the illustrative case where the original delivery point includes a P.O. Box. This implementation of the mail manager site includes a scanner 21 coupled to a workstation 22. The scanner may be any one of a variety of types of document scanners which is preferably coupled to a digital processor 23. The workstation is coupled between the scanner and communications network, and preferably includes a personal computer loaded with application software for receiving and processing images from the scanner and/or the digital processor. This same software may perform the interactive and management functions discussed herein.

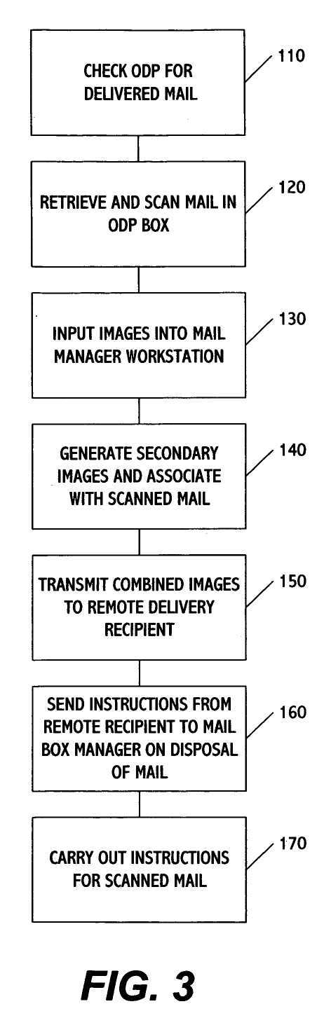

In operation, as shown in the flow chart of FIG. 3, the mail manager checks to determine whether mail items have been delivered to the P.O. Box. (Block 1 10). The delivery may occur once a day (e.g., in the case of the U.S. Mail) or multiple times a day, for example, when the mail items correspond to FedEx packages, UPS shipments, or the like. Accordingly, the mail manager may be tasked to check the mail periodically, e.g., according to a predetermined daily schedule.

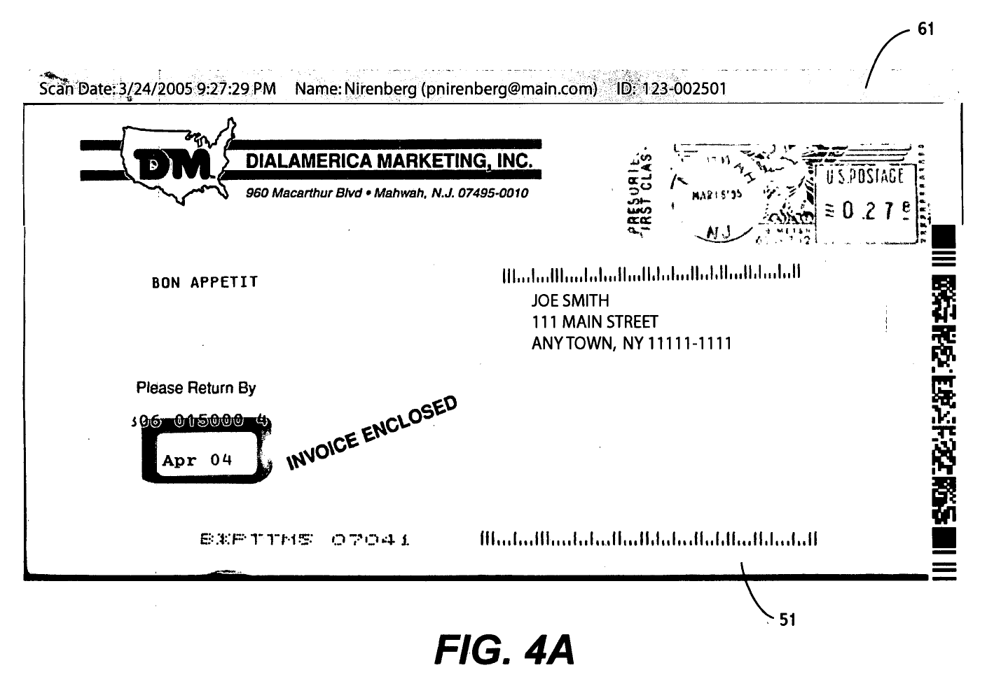

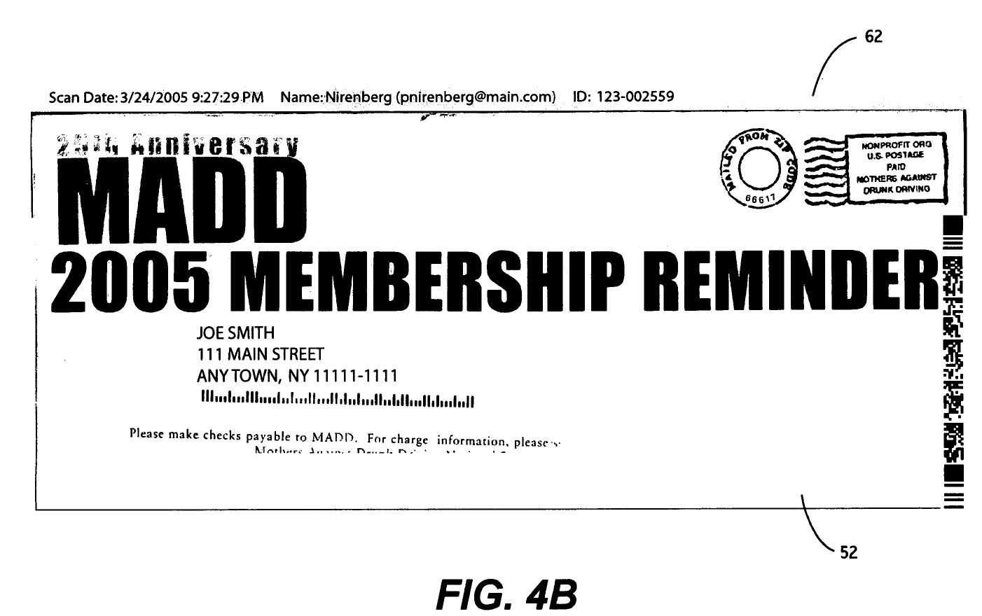

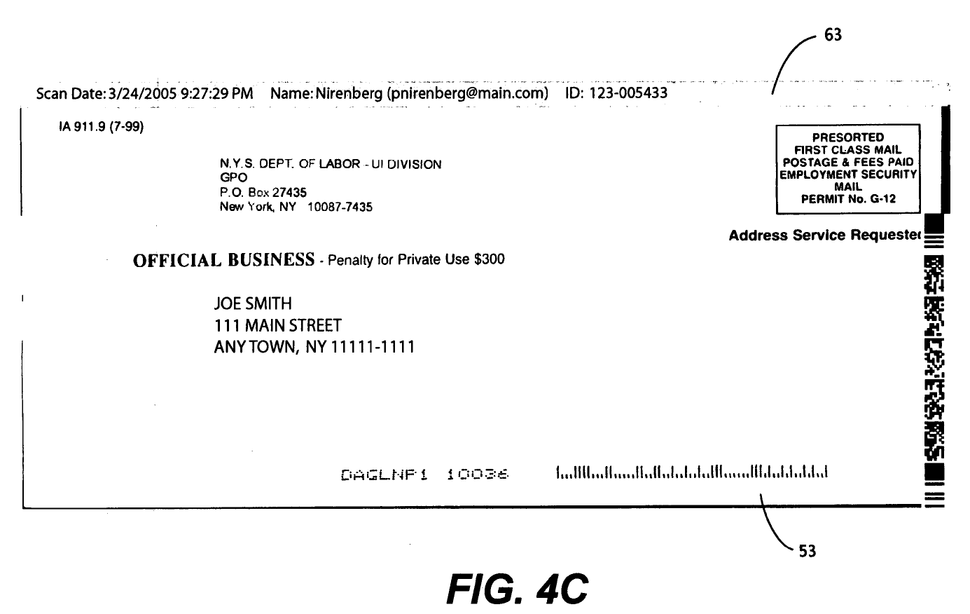

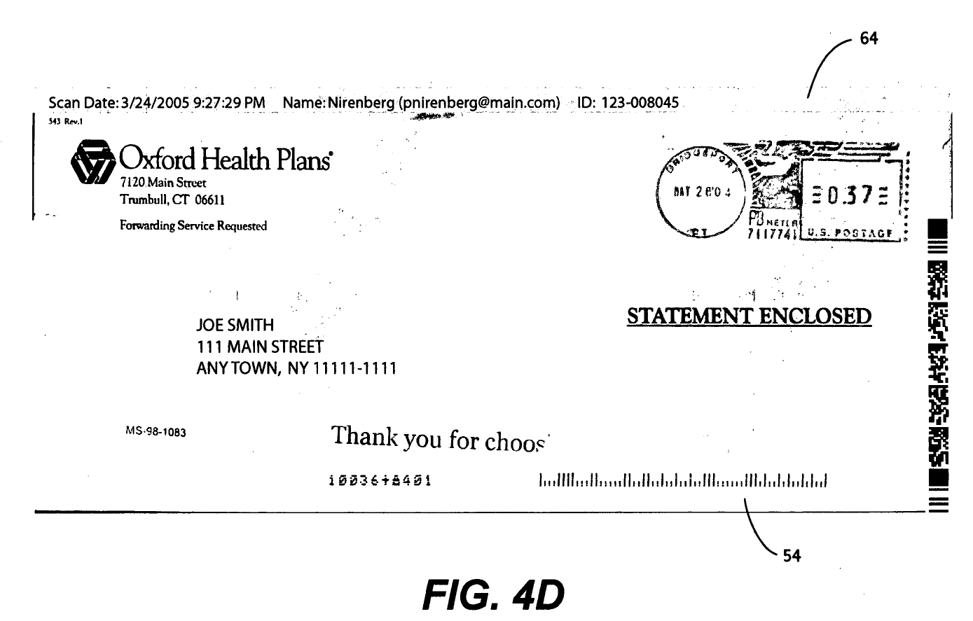

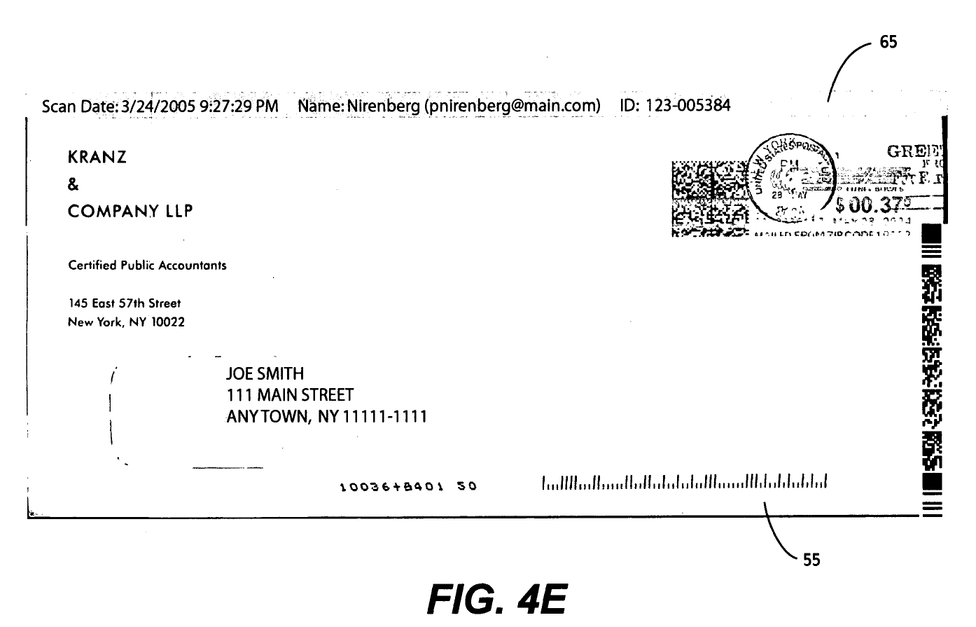

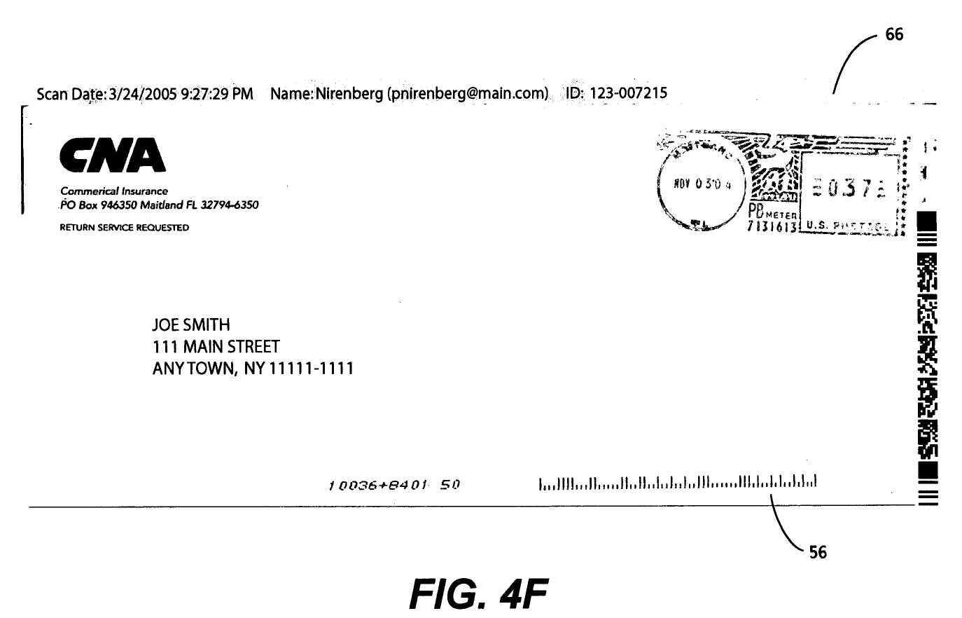

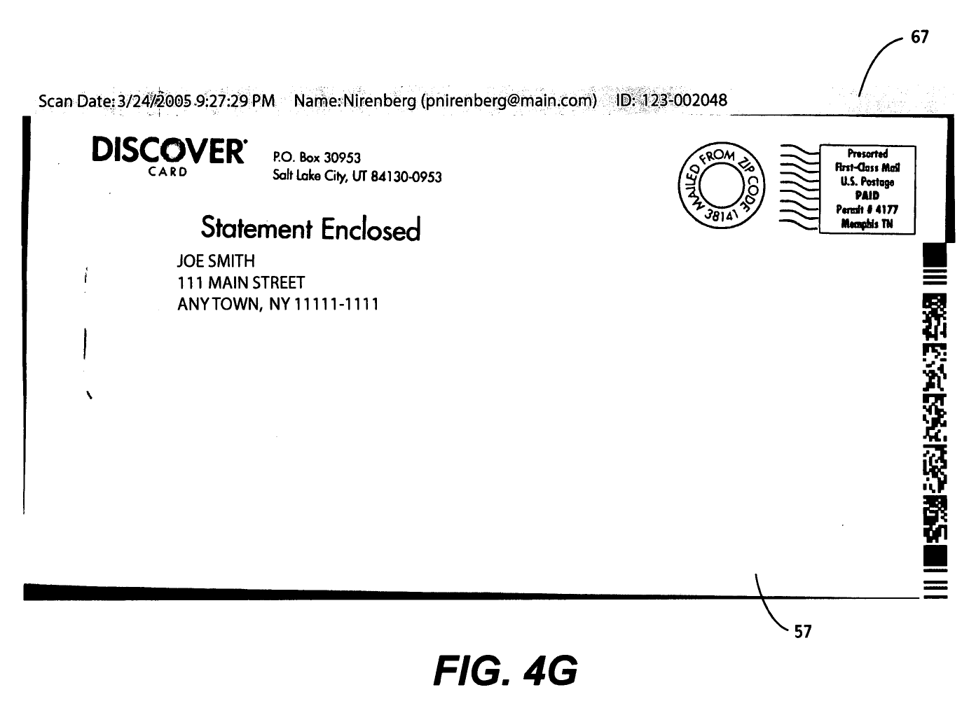

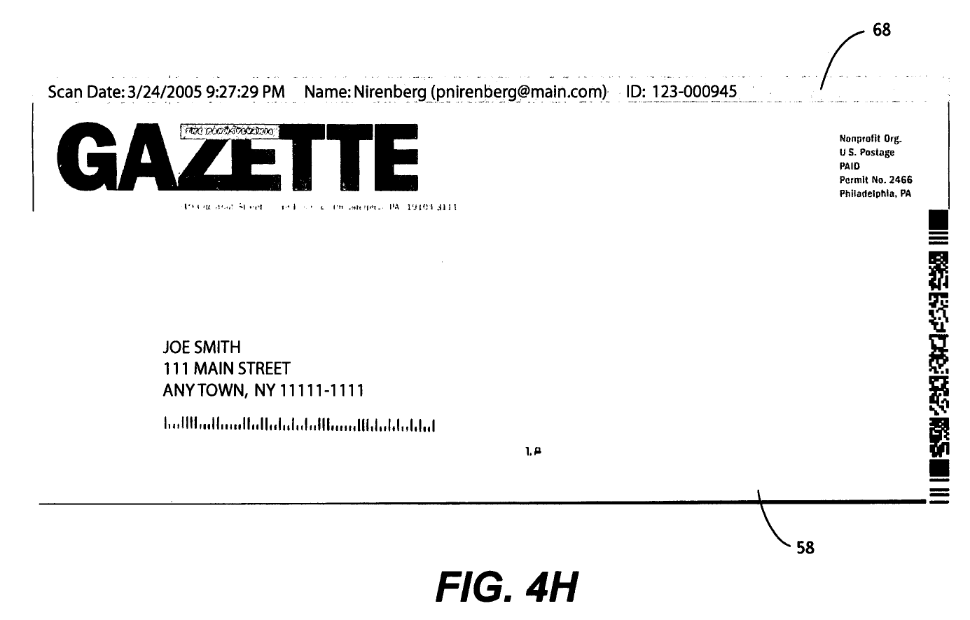

When the mail manager discovers that one or more mail items have been delivered to the box, the items are retrieved and scanned by scanner 21. (Block 120). The scanner scans at least one side of each unopened mail item to capture addressor and/or other information useful, for example, in determining the sender's identity. If the item is an envelope, at least all or a portion of the front side of the envelope is scanned. Capturing an image of the entire front side will allow the remote delivery recipient to view or otherwise determine, for example, not only the sender's identity but also any markings or instructions on the envelope. These markings or instructions may relate, for example, to the status, contents, etc., of the mail items Examples of these markings include but are not limited to “Invoice Enclosed,” “Fragile,” “Time Sensitive Material,” “Photos Enclosed,” “Please Return by” dates, forwarding messages, bar codes, zip-code information, delivery methods and/or routes, and/or other information. Some of these examples are shown in the scans set forth in FIGS. 4A-4H.

The scanned front-sides of the mail items preferably include the addressee field. This is useful, for example, when the remote mail recipient is a business having multiple employees, e.g., by scanning the addressee field the appropriate corporate personnel may be notified that they have received letters in the box.

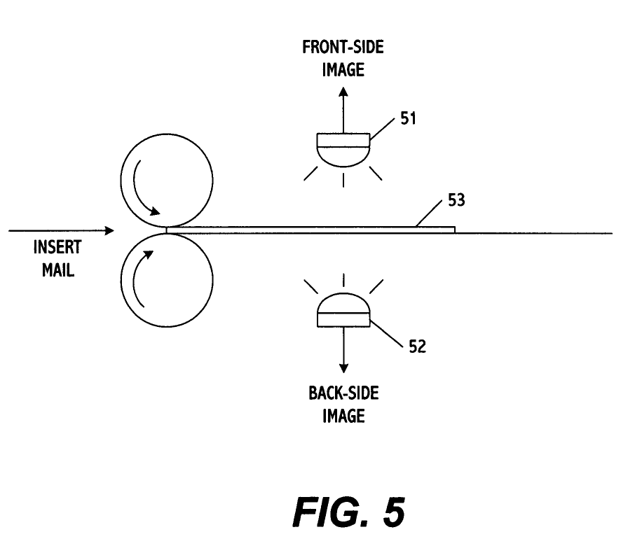

FIG. 5 shows how scanning may be performed in accordance with one particularly advantageous embodiment. Here, scanning is performed by a scanner having two heads 51 and 52, one which captures all or a portion of a front-side image of a mail item 53 and another which captures all or a portion of a back-side image of the mail item. For efficiency reasons, the two images are preferably captured simultaneously, although this is not a necessity. Scanning the back-side of a mail item may be useful, for example, to capture information (e.g,. addessor information) not included on the front-side portion of a mail item. Of course, in other embodiments only the back-side may be scanned if desired.

In the case where the mail items are packages, parcels, or ones have large or irregular shapes, scanning may be performed on any side bearing information of interest. Preferably in all embodiments, the scanning may be performed by machine (e.g., with an automated insert port) or hand-scanner, and the captured images may be in color or black and white.

Once the images have been scanned, they may be input into the workstation for archival and/or processing. (Block 130). Preferably, the images are indexed with past images of mail items delivered to the same box. The past images may be retained for a predetermined time and then discarded to free up the memory capacity of the workstation.

Prior to archival, several processing operations may be performed. For example, a secondary image may be generated in association with each scanned mail item to designate one or more of the following: time and date the item was scanned, name of the customer or box owner, contact information for the customer or box owner, and code or other information relating to the customer or box owner's identity and/or business. (Block 140). Examples are shown by reference numerals 61-68 in FIGS. 4A-4H.

The secondary images may be generated by a graphics or digital processor which, for example, may be located in or correspond to the workstation computer, the scanner, and/or digital processor located 23 in advance of the scanner. If the workstation computer is used for this purpose, the computer may generate and then append, superimpose, or otherwise associate secondary images 61-68 to respective ones of the primary scanned images 51-58 captured by the scanner, thereby creating a digital envelope. The computer may generate the secondary images based on client identification and/or other information input by a user into the computer. Alternatively, the workstation computer may be loaded with optical character recognition software which, for example, reads and identifies the addressee in the scanned image and automatically retrieves associated customer information stored in memory for purposes of generating information included in each of the secondary images.

The secondary images may also be generated by a graphics processor within or coupled to the scanner. The secondary images may contain the same information as above entered, for example, through a scanner keyboard or a computer (e.g., the workstation) coupled to the scanner. Alternatively, the scanner may include optical character recognition software to be used in retrieving information from memory in a manner similar to the process described above. The processor may then append, superimpose, or otherwise associate the secondary images to respective ones of the primary images of the scanned mail items for transmission to the workstation. As a further alternative, the primary and secondary images may be separately sent to the workstation, where they may then be appended to, superimposed on, or otherwise associated with one another.

The secondary images may also be generated using digital processor 23 positioned in advance of the scanner. Like in previous cases, the secondary images may be generated based on customer identification and/or other information manually input into the processor or retrieved from memory after optical character recognition. The secondary images may be appended to, superimposed on, or otherwise associated with one another in the scanner or workstation.

Once combined images have been formed from respective pairs of primary and secondary images, the combined images may be transmitted to the remote delivery recipient through the communications network. (Block 150). The combined images may transmitted in a variety of ways. For example, each combined image may form a separate attachment to an e-mail sent to the remote delivery recipient, or the images may be separately transmitted. Alternatively, reduced-size (often called “thumbnail”) images of each combined image may be included preferably in a single-page image (formed, for example, using HTML language) transmitted or otherwise made available to the remote delivery recipient through the Internet.

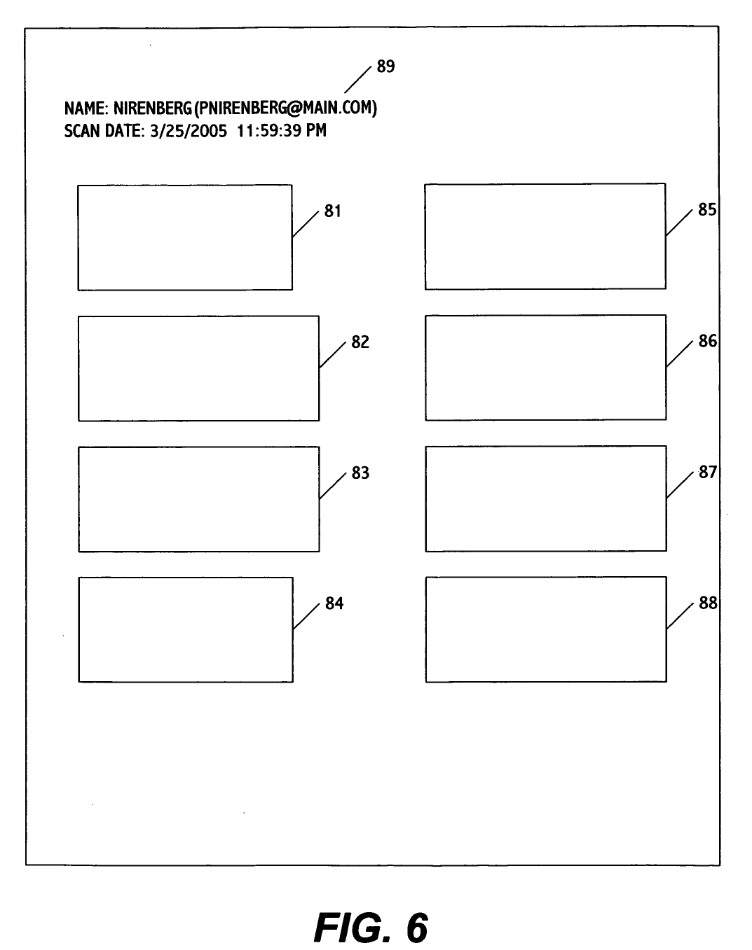

FIG. 6 shows an example of this thumbnail transmission. In this embodiment, thumbnail images 81-88 included in a single HTML page are transmitted to the remote delivery recipient through the Internet. Each thumbnail image may be a combined image of a delivered mail item with a secondary image, or a primary image of a scanned mail item without a secondary image. The HTML page may also include an information field 89 including, for example, one or more of the types of information included in the secondary images previously discussed.

Whether in singular or combined form, the scanned images may alternatively, or in addition, be accessed through a website. For example, a notification e-mail may be sent to the remote delivery recipient with or without a hyperlink to the scanned images. If a hyperlink is included, clicking on the hyperlink will automatically give the remote delivery recipient access to the scanned images. A logon operation may be required before access is complete.

Alternatively, the images may be made available on a website maintained by the mail manager. This website may be password protection and require, for example, entry of an account number and/or other information before the images may be remotely accessed and downloaded to the delivery recipient's computer. While the remote delivery recipient may access this website at any time, an e-mail may be sent in advance to notify the delivery recipient that scanned mail is now available for viewing. A server may be located or coupled to mail box manager workstation 2 to make these embodiments possible.

Once the images have been viewed, the remote recipient sends one or more instructions to the mail box manager concerning disposition of the mail items. (Block 160). When the images are made available through the Internet, the remote recipient computer is preferably loaded with application software which makes designation of the instructions very convenient. This software, for example, may generate a graphical user interface window with tools that allow the remote recipient to designate how the mail items shown in each scanned image should be handled.

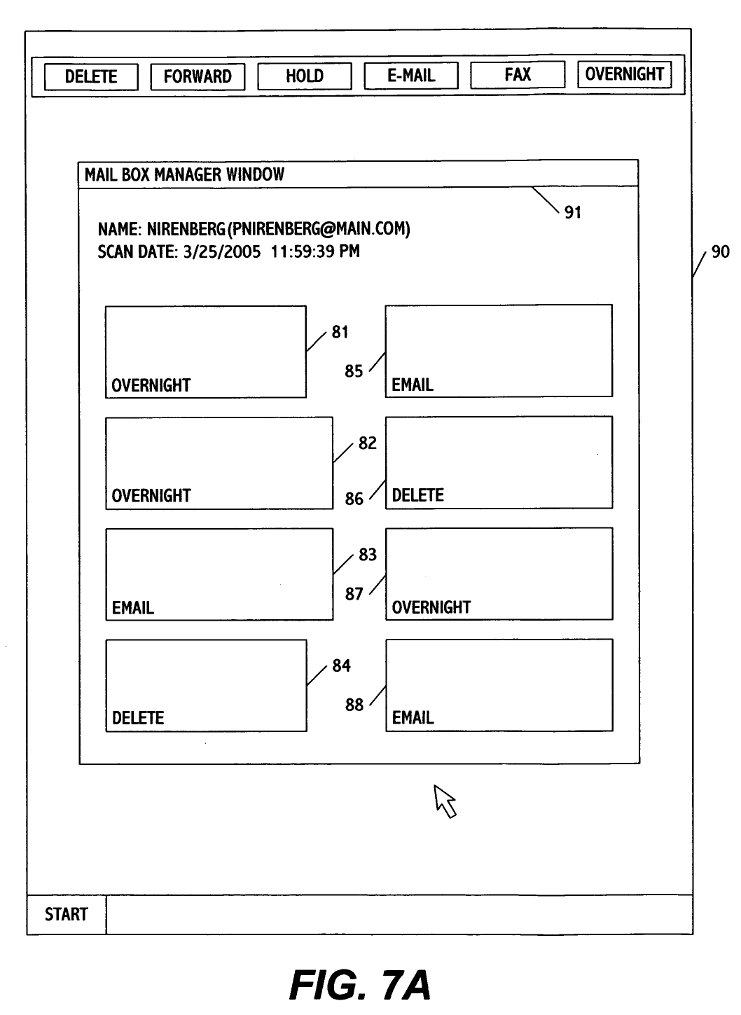

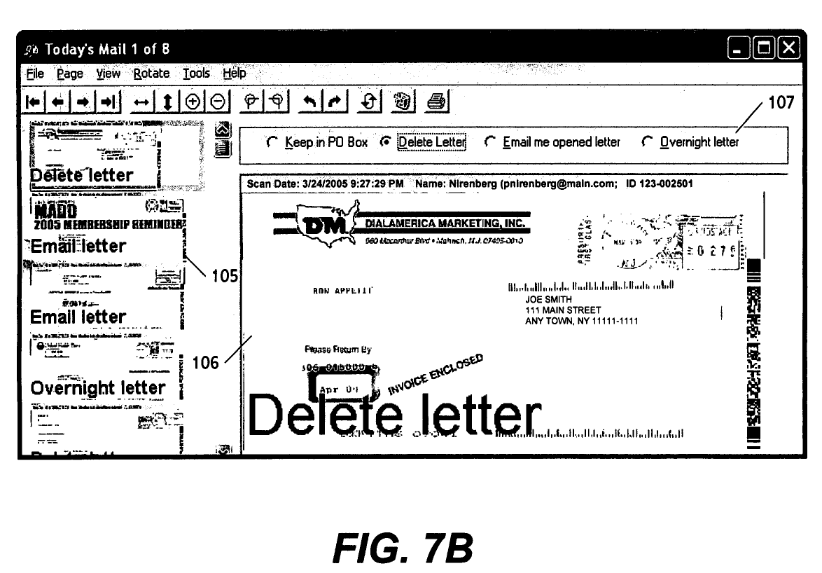

FIG. 7A shows an example of such a graphical user interface 90 with a tool bar 91 and a mail box manager window 92, which in this illustrative case includes thumbnail images 81-88 of each scanned mail item with secondary images appended. When the remote recipient clicks on one of the thumbnail images, the tool bar may become active for that image. Then, the recipient may click on tool bar icons to designate, for example, whether the mail item depicted should be discarded, forwarded to a particular address, e-mailed to a particular address, faxed, or held on behalf of the recipient. Other or different options may also be available. For example, the tool bar may include an icon to designate that items should be opened and their contents scanned. The scanned contents may then be e-mailed and/or faxed to the recipient to a certain number or address of record.

The application program may also generate a graphic indicating a result of the tool bar designation. The graphic may be superimposed or otherwise associated with each of the thumbnail images. For example, thumbnail images 81, 82, and 87 may be individually selected and designated with the graphic “Overnight,” indicating that the mail manager should send corresponding mail items to the remote delivery recipient by overnight courier. Thumbnail images 84 and 86 may be individually selected and designated with the graphic “Delete,” to indicate that the mail manager should discard corresponding mail items from the P.O. Box. Thumbnail images 83, 85, and 88 may be individually selected and designated with the graphic “Email,” to indicate that the mail manager should open the corresponding mail items, scan their contents, and e-mail the scan contents to the remote mail recipient.

The tool bar icons are merely illustrative of the types of instructions the remote delivery recipient may provide in relation to the scanned mail items. The following is a non-exhaustive list of these instructions, which may be designated by one-click actions or otherwise:
Discard/Delete
Destroy, e.g., by shredding
Forward to Remote Recipient's or Another address (electronic, fax, or physical)
Open and report contents
Open and scan contents, and forward scan by e-mail, fax, courier, mail, etc.
Hold in a special, separate area or container
Ignore/Do Nothing and Keep in Box for Physical Pick-Up
Expedited delivery (e.g., overnight, courier, weekend, Monday delivery, etc.)

After one or more instructions have been sent, the mail items themselves may be sent from the mail manager to the remote delivery recipient in accordance with the instructions, additional instructions, and/or the terms of a pre-arranged agreement. Also, or alternatively, the mail manager workstation may generate and transmit information in an e-mail, or otherwise make available on a website a screen such as shown in window 92 with associated graphics, as a confirmation that the instructions have been carried out by the mail manager.

FIG. 7B shows another example of a graphical user interface that may be implemented on the computer of the remote delivery recipient. This interface includes a first window or section 105 displaying reduced-size or thumbnail images of the scanned images received by the mail manager. These images may or may not include or being associated with the secondary images discussed above. A second window or section 106 displays an enlarged view of the image when, for example, its corresponding thumbnail image is selected from the first window. By accessing soft buttons provided by the graphical user interface, any portion of the image displayed in the second window may be rotated, zoomed, selected for printing, etc.

A tool bar 107 is also included with icons which can be selected to provide instructions with respect to mail items displayed in the second window. While these options are shown to be “Keep in PO Box,” “Delete Letter,” “Email me opened letter,” and “Overnight Letter,” it is understood that any of the options, instructions, or commands described herein may be listed as a selectable icon on the tool bar. (It is further understood that the terms options, instructions, and commands are used synonymously herein.)

After a tool bar selection is made, the application software installed in the remote recipient's computer may generate and associate (e.g., append, superimpose, etc.) a corresponding graphic across the image in the second window. Once instructions have been provided for all or a portion of the mail items, the images with associated graphics may be sent back to the mail manager, for example, in a reply e-mail. This reply e-mail is advantageous because it further provides a basis for establishing an audit trail/tracking function.

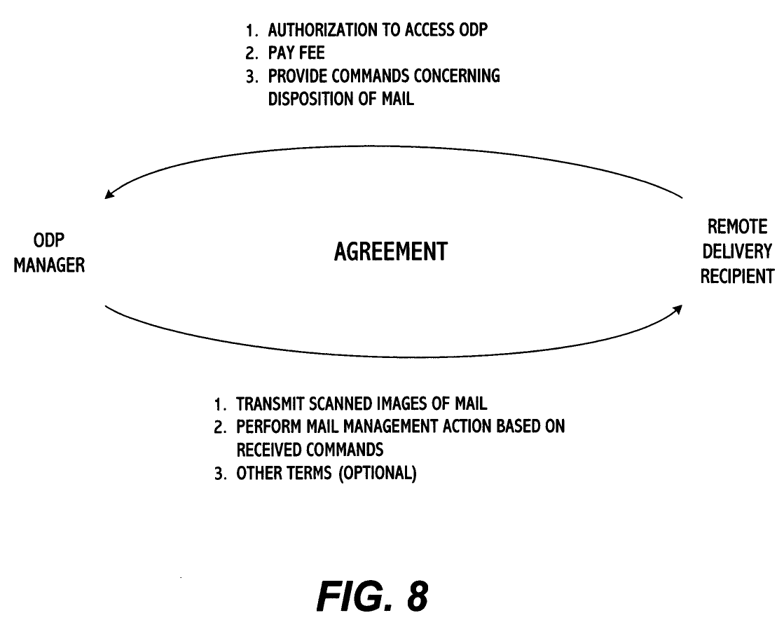

FIG. 8 shows an example of how such an agreement may be structured. The initial relationship between the mail manager and remote delivery recipient may involve the remote recipient leasing a mail box or securing another type of original delivery point. The mail box may be leased from the mail manager or from another party. Either way, the remote delivery recipient may agree to: (a) give the mail manager authorization to access the contents of the mail box, (b) pay a fee for management services, and (c) provide commands in response to receiving scanned mail items after they have been delivered to the box. In return, the mail manager may agree to: (a) retrieve and transmit scanned images of the mail items delivered to the box and (b) carry out instructions provided by the remote delivery recipient regarding the disposition of mail corresponding to the scanned images.

In terms of the fee, the mail manager may provide the aforementioned services, for example, as a monthly price increment to current rental contracts. Additional charges may be incurred, for example, for additional services such as scanning, overnight delivery of mail items, audit trail tracking, accounting functions, electronic invoicing, as well as other services.

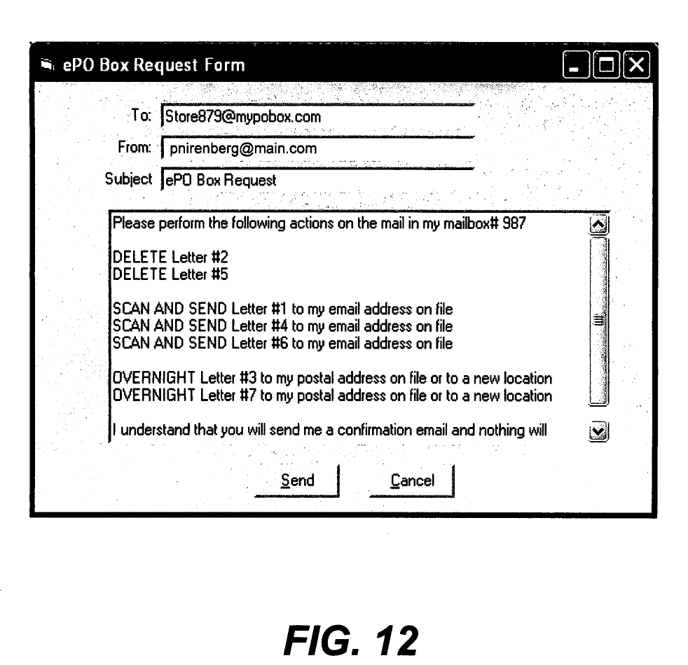

As a further alternative, the remove delivery recipient may fill out an on-line form designating how the mail items corresponding to each scanned image should be disposed of. This on-line form may include, for example, checkable boxes adjacent each of a plurality of predetermined command graphics displayed on a screen. Other ways of designating commands or instructions may alternatively used. For example, as shown in FIG. 12, these same instructions may be provided in textual form, for example, in a reply e-mail or fax sent from the delivery recipient to the mail manager.

Once instructions have been received from the remote delivery recipient, the mail manager carries out the instructions for the delivered mail items. (Block 170). If the instruction is to hold one or more the mail items, the items may be placed in a separate container or box reserved for the recipient. If the instruction is to destroy the mail items, they may be destroyed, for example, simply by discarding them into the trash or shredding them. If the delivery recipient is a large corporation, the mail manager may have a relationship with one or more public or private carriers to have the mail delivered in bulk to the recipient's address.

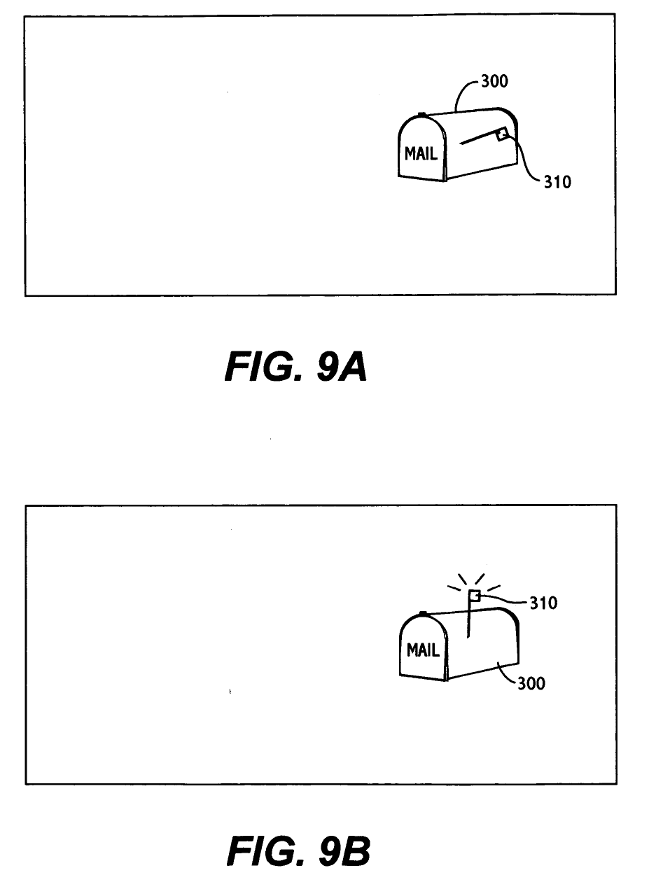

The post-delivery mail management system and method may include a number of additional features. For example, the application software installed at the computer of the remote delivery recipient may activate, animate, and/or modify a desktop icon when notification is received from the manager (with or without scanned images) that mail items have been delivered to the original delivery point. For example, when the remote delivery recipient's computer receives an e-mail or signal from the mail manager's website indicating that mail has been received, the application program may modify a mail box icon 300 having a flag 310 in the down position (FIG. 9A) to one having the flag in the up position (FIG. 9B). To implement this function, the application may be left running on the desktop and may be equipped with any one of a plurality of known operating systems or programs that will notify the application software of a received signal or e-mail. Alternatively, this functionality may be written directly into a browsing function of the application software.

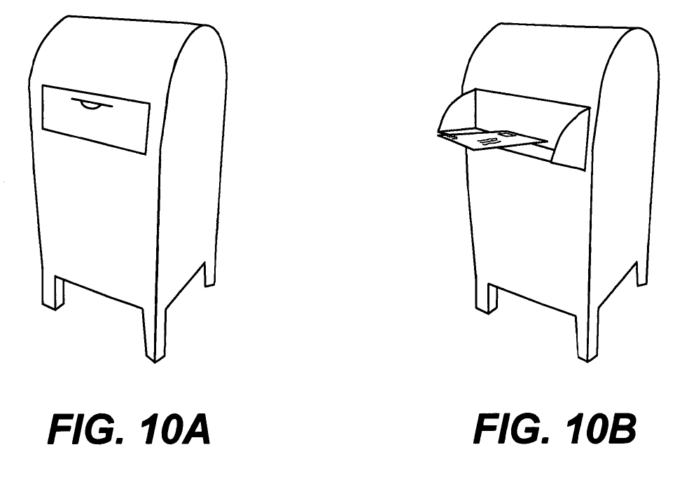

As a further alternative, a postal mail box icon 320 having a door 3330 in the shut position (FIG. 10A) may be modified to have its door in the open position (FIG. 10B). In either of the foregoing instances, the change may be animated, e.g., the flag may be shown to move from the down position to up position in a continuous manner, or the postal mail box door may be shown to go from a closed position to an open position in one continuous manner.

Also, leasing of the original delivery point and/or the agreement between the mail manager and remote delivery recipient may be arranged using an electronic application. For example, the remote delivery recipient may fill out an on-line form (e.g., an electronic application) on the mail manager's website to register the original delivery point with the manager, to provide the manager with authorization to access the mail delivered to that point, and to carry out any one or more of the instructions mentioned above.

As a further alternative, the scanner may be equipped with an ink jet or other printer for applying information (e.g., any of the information included in the secondary images) to delivered mail items before or during scanning. If applied before scanning, no secondary images would be necessary, e.g., images of the scanned mail items would be transmitted to the remote delivery recipient without the secondary images appended or superimposed.

As a further alternative, additional image processing techniques may be performed on the scanned mail items. For example, a digital envelope may be created by superimposing bar codes or other information on captured images of the scanned envelopes. This information may be superimposed on both the front and back sides of the envelopes or other mail items. Moreover, all transmissions between the mail manager and remote delivery recipient may be encrypted for security.

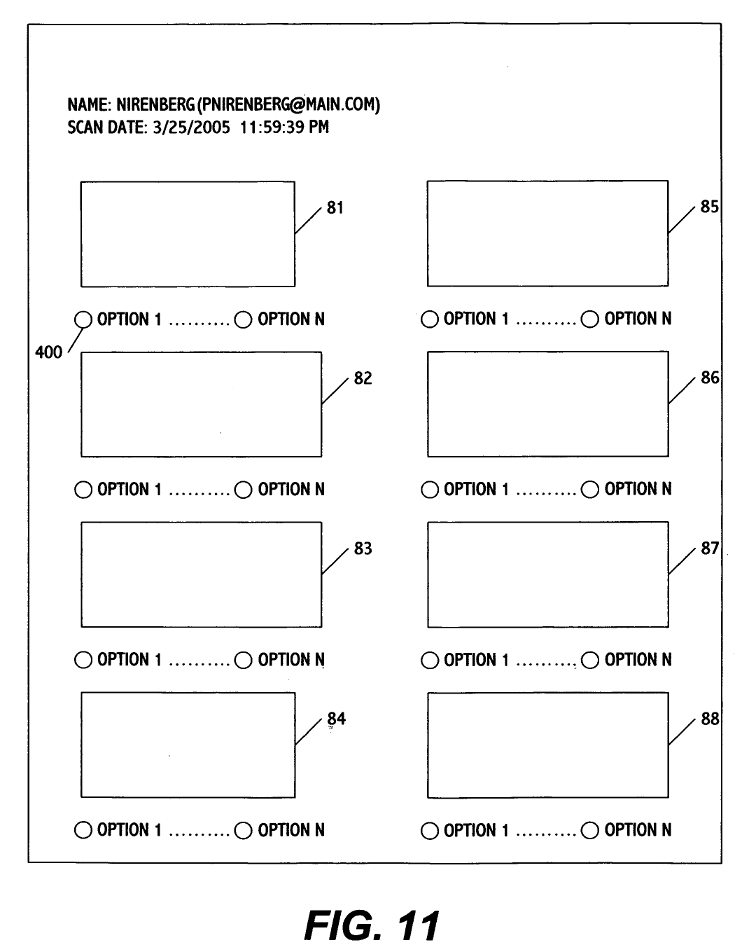

As a further alternative, FIG. 11 shows scanned images of mail items which may be transmitted electronically to the remote delivery recipient, either through a website access or in an e-mail. As shown, a list of options 400 are generated with each of the scanned images. The options preferably correspond to all or a portion of the instructions mentioned above, and may be designated, for example, through a point-and-click selection by the remote delivery recipient. The scanned images along with the selected options may then be sent back to the mail manager, for example, through a reply e-mail or download to the mail manager website. The thumbnail transmission shown in FIG. 6 may also be sent to the remote delivery recipient by e-mail if desired.

As a further alternative, special sheets containing a predetermined list of options, instructions, or other designations may be scanned with the mail items delivered to the box or other delivery point. The special sheet may filled out in terms of customer name, customer code, time of scanning, scanning source, etc., and may include a box or space adjacent each option. The scanned images are then transmitted to the remote recipient, who prints out the sheet and checks the appropriate boxes concerning disposition of the mail items. The sheet is then sent back to the mail manager, e.g., by fax or scanned e-mail attachment.

As a further alternative, the mail manager workstation may send a confirmation e-mail or other communication to the remote delivery recipient indicating that the instructions have been received and/or that action has been taken based on the instructions. If instructions are given for additional services (e.g., overnight delivery of mail items to a desired address), then a price quote may be computed and sent to the remote delivery recipient before the mail manager performs the action. The price quote may be sent by fax, e-mail, telephone, or other method, and may be sent with a request for additional instructions (e.g., overnight delivery address), if necessary. The action may be performed only after the mail manager receives approval of the quote.

If no approval is received, for example, within a predetermined period of time, the mail items may be retained at the original delivery point for pick-up or until another request is made. All of the foregoing steps may be performed, for example, by one-click actions. Even if no approval is given, the remote recipient may print out the transmitted images of the mail items for his or her records.

As a further alternative, the instructions sent (e.g., FIGS. 7A or 11) by the remote delivery recipient may be sorted (e.g., based on instruction type) by the mail manager. This may make it easy for the staff at the mail manager site to perform its functions. For example, sorting may be performed for multiple mail boxes owned by the same or different entities. In this case, a staff employee may go into all boxes that have delivered items designated for deletion, discarding, or destruction and perform these functions at one time.

In addition to the foregoing advantages, the embodiments of the present invention may prove to be particularly useful at business office centers which, for example, store mail for so-called “virtual businesses.” These centers may be technically savvy but do not necessarily have to be a “tech” store. For example, in a basic application, the mail manager site would only require a fax and/or network connection to the internet, power for the scanner, counter space (e.g., 4 feet may be all that is necessary), and perhaps one person trained for light and/or technical maintenance.

The embodiments of the invention may also provide a basis for generating new forms of revenue. For example, the invention may be implemented as an add-on feature to current box rentals. Service fees may be assessed, for example, based on the size of the box. Opening and scanning mail items may be assessed as separate charges, as well as courier and overnight delivery. The business center may realize the additional revenue. In terms of expenses, the center may pay for monthly lease of the equipment and Internet services.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention.

We claim:

1. A post-delivery mail management system, comprising:
a scanner to capture a first image of at least one side of a mail item delivered to an original delivery point;
a digital processor to associate a second image with the first image of the mail item, said second image including information relating to a management function performed by a manager of the original delivery point in relation to the mail item; and
a workstation to transmit the first image of the mail item with the associated second image to a remote delivery recipient, wherein the workstation receives one or more interactive commands from the remote delivery recipient indicating a manner of disposition of the mail item.

2. The system of claim 1, wherein the second image includes textual information relating to the remote delivery recipient.

3. The system of claim 2, wherein the textual information includes at least one of an identification code, identification number, a name, and an address of the remote delivery recipient.

4. The system of claim 1, wherein the workstation transmits the first image of the mail item with the appended second image according to a predetermined schedule programmed into a workstation processor.

5. The system of claim 1, wherein the workstation transmits the first image of the mail item with the appended second image in response to activation of a hyperlink signal received through the Internet.

6. The system of claim 1, wherein the workstation transmits the first image of the mail item with the appended second image as an e-mail attachment.

7. The system of claim 1, wherein the workstation transmits the first image appended to the second image in response to a request signal transmitted by the remote delivery recipient.

8. The system of claim 7, wherein the request signal is received through a website corresponding to the manager of the original delivery point.

9. The system of claim 1, wherein the scanner captures front-side and back-side images of the mail item, and wherein the digital processor appends the second image to at least one of the front-side and back-side images for transmission by the workstation to the remote delivery recipient.

10. A post-delivery mail management method, comprising:
receiving a first electronic signal at a terminal of a remote delivery recipient, said first electronic signal including at least one image of a scanned mail item delivered to an original delivery point;
displaying the at least one image of the scanned mail item on a screen of the terminal;
generating a second electronic signal including at least one command relating to a manner of disposition of the mail item delivered to the original delivery point; and
transmitting the second electronic signal from the terminal to a manager of the original delivery point in response to the first electronic transmission.

11. The method of claim 10, further comprising:
displaying options for managing the mail item on the terminal screen; and
receiving a signal from an input device selecting one or more of said options, wherein the instruction in the second electronic signal includes information indicating the one or more selected options.

12. The method of claim 11, wherein the options are displayed as selectable icons on the terminal screen.

13. The method of claim 12, wherein the selectable icons are displayed in association with the at least one image of the mail item displayed on the screen.

14. The method of claim 10, further comprising:
associating a graphic indicative of the at least one command with the image of the mail item; and
transmitting the electronic signal to include the graphic in association with the image of the mail item.

15. The method of claim 10, further comprising:
logging on to a website of the manager of the original delivery point;
sending a request for status of the original delivery point through the website; and
receiving the first electronic signal in response to said request.

16. The method of claim 10, further comprising:
receiving notification that mail has been delivered to the original delivery point;
sending a request in response to activation of a hyperlink on the terminal screen; and
receiving the first electronic signal in response to said request.

17. The method of claim 10, wherein the first electronic signal is received with an e-mail sent from the manager of the original delivery point.

18. The method of claim 10, wherein the second electronic signal is transmitted as an e-mail to the manager of the original delivery point.
